(19) United States
(12) Patent Application Publication
(10) Pub. No.: US 2012/0269925 A1
(43) Pub. Date: Oct. 25, 2012

(54) AUTOMATED WINEMAKING SYSTEM AND WINEMAKING METHOD THEREOF

(76) Inventor: Carlo Farotto, San Maurizio Di Conzano (IT)

(21) Appl. No.: 13/508,794

(22) PCT Filed: Nov. 10, 2009
(86) PCT No.: PCT/IT09/00503

§ 371 Date: Jul. 5, 2012

(51) Int. Cl. C12G 1/022

(52) U.S. Cl. 426/15; 99/276

(57) ABSTRACT

An automatic winemaking system is disclosed, which controls the execution of a winemaking process for the alcoholic fermentation of must obtained from a batch of grapes and the transformation thereof into wine in a winemaking tank. The system is provided with a database for storing winemaking data related to reference winemaking processes; a first processing unit for generating an optimized winemaking model, according to the winemaking data contained in the database, according to input data including characteristics of the batch of grapes and/or must; and a second processing unit for controlling and driving actuators acting on the winemaking tank according to the optimized winemaking model, so that winemaking process parameters are optimized for the features of the batch of grapes and/or must. The second processing unit is further capable of signaling fermentation kinetics faults and/or signaling alarms during the winemaking process.

### TECHNICAL FIELD

The present invention relates to an automated winemaking system and to a winemaking method thereof.

### BACKGROUND ART

Over the past years, considerable progresses have been made in the field of winemaking management and control, i.e. the operations as a whole which contribute to the production of wine by alcoholic fermentation of the starting liquid-solid mixture, i.e. the must or, as it is intended herein, the crushed grapes.

For example, winemaking tanks have been created, the tanks being equipped with automatic pumping-over systems and systems for controlling the temperature with the possibility of hot and cold contribution, managed with the support of processing units which acquire data from a series of sensors arranged aboard the same tanks, adapted to detect, for example, the density of the must, the developed mass flow of carbon dioxide (CO₂), the temperature of the must, etc. Such systems allow the user to monitor the fermentation process and to manually adjust the winemaking parameters (including increasing and/or decreasing temperature, adding nutrients, operating pumps and mechanical must mixing actuators, etc.).

However, despite the mentioned progress, it can certainly be stated that the winemaking process management is still very far from being optimized, because it is, for example, strongly bounded to human choices, often based on personal experience and empirical data and not on an analytic, scientific interpretation of chemical/physical data collected, for example, during the step of pre-harvesting of the grapes and of later fermentation thereof.

Furthermore, equipment is not currently available for reliably identifying and then implementing automatic and/or manual actions aimed at correcting faults during the winemaking process, such as the so-called “fermentation stops” or, in contrast, excessively rapid fermentation kinetics, which, if neglected, inevitably cause the declassification of the final product with consequent considerable quality and economic damage.

The need to apply efficient, effective winemaking procedures is thus felt especially by the most dynamic winemakers attentive to final product quality, procedures which are in particular assisted by a scientific, repeatable approach and in which the result is according to determined targets with regards to the features of the starting material. Furthermore, the need for obtaining a more accurate winemaking process control during execution thereof is most certainly felt.

### DISCLOSURE OF INVENTION

It is the object of the present invention to solve the aforesaid problems as a whole or in part and to fulfill the aforesaid needs.

According to the present invention, an automated winemaking system and a corresponding winemaking method are thus provided, substantially as defined in the accompanying claims.

### BRIEF DESCRIPTION OF THE DRAWINGS

For a better understanding of the present invention, it will now be described a preferred embodiment only by way of non-limitative example, and with reference to the accompanying drawings, in which:

FIG. 1 shows a diagrammatic view of a winemaking automated system, according to an aspect of the present invention;

FIG. 2 shows a logical diagram of the operations carried out according to the winemaking method implemented by the system in FIG. 1;

FIG. 3 shows the possible content of winemaking database in the system in FIG. 1;

FIG. 4 shows a simplified diagram of a neural network used in the system in FIG. 1; and

FIGS. 5 and 6 show plots related to controlled variables in the system of FIG. 1.

### BEST MODE FOR CARRYING OUT THE INVENTION

As will be described below in greater detail, an aspect of the present invention consists in processing, in particular by means of an appropriately trained neural network, a collection of historical data concerning passed winemaking processes, scientifically and systematically stored in an appropriate database in order to obtain, by means of a data mining process, an optimal winemaking model, optimized for the particular features and conditions of the winemaking process which will be undertaken.

A further aspect of the present invention thus contemplates managing and controlling the winemaking process being performed on the basis of the previously processed optimized model, by using an appropriate artificial intelligence unit, in particular implementing fuzzy logic algorithms, capable of implementing self-adapting and adjusting operations with reference to the optimized model for preventing/avoiding/attempting to solve possible fermentation kinetics abnormalities, both automatically and by sending alarms and working orders to operators.

A yet further aspect of the present invention contemplates enlarging the aforesaid database at the end of each winemaking process using the information gathered during the same winemaking process, and possible further information deemed important (collected at later moments of time), so as to continuously increase the content of the database and consequently make the optimized winemaking models—which will be then processed starting from such a database—increasingly more accurate and reliable.

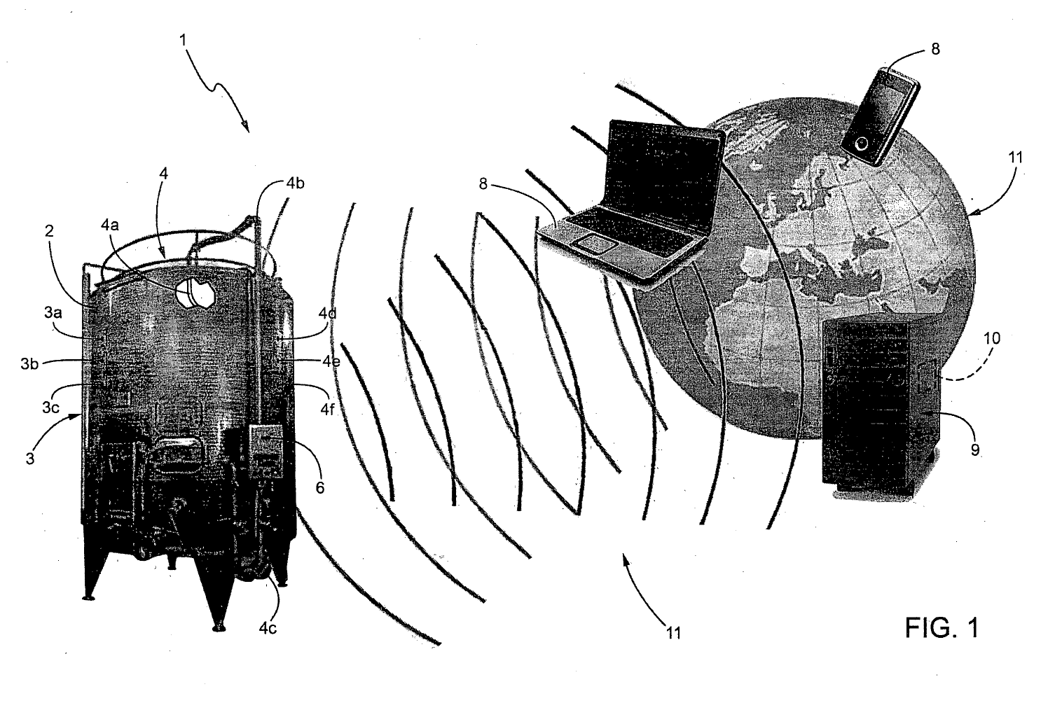

In detail and with reference to FIG. 1, the automated winemaking system, indicated as a whole by reference 1, in a currently preferred embodiment, comprises:
a winemaking tank 2, adapted to contain a liquid-solid mass (must or crushed grapes) subjected to maceration/fermentation during the winemaking processes for its transformation into wine;
a plurality of sensors, indicated as a whole by reference 3 and operatively coupled to the winemaking tank 2, adapted to detect a plurality of relevant winemaking process quantities, and including: a temperature sensor 3a and a pressure sensor 3b (shown schematically) for monitoring the density of the mixture within the winemaking tank 2; a flow rate sensor 3c (shown schematically) for monitoring the production of carbon dioxide (CO₂) in gaseous phase; and further sensors (not shown) for detecting further chemical/physical parameters of the same mixture;
a plurality of actuators, indicated as a whole by reference 4 and actuatable for intervening on the processing of the mixture, including: an automatic winemaking robot (or robotized arm) 4a, capable of actuating light spraying operations (also known as “arrosage” operations), classic pumping-over and vigorous punching-down (or “pigeage”); a suction pipe 4b associated to a pumping-over pump 4c of the mixture, having the function of aspirating part of the mixture from a lower portion of the winemaking tank 2 and sending it to an upper portion of the tank itself, so as to remix the mixture; a dispensing pump of nutrients, anti-oxidants and other additives (not shown); a porous diffuser 4d (shown schematically) for blowing oxygen (O₂) and a dosing chamber thereof; a first serpentine 4e (shown schematically) for heating and increasing the temperature of the mixture; and a second serpentine 4f (shown schematically) for chilling and decreasing the temperature of the same mixture;
a control unit 6, e.g. of the microprocessor type, coupled to the winemaking tank 2 (e.g. being arranged aboard the tank itself), and operatively coupled both to the sensors 3, to detect the signals related to the detected quantities concerning the winemaking process, and to the actuators 4, so as to actuate, on the basis of the data output by the same sensors 3 and appropriate processing (in particular, by means of suitable fuzzy logic algorithms), the actuators in order to implement appropriate corrective winemaking process actions and/or to activate appropriate alarm indications; in particular, the control unit 6 executes a program and a set of software instructions in order to check that the winemaking process follows a particular optimized winemaking model which was previously received and stored within a corresponding memory;
a local processing unit 8, e.g. in the form of a laptop computer, PDA, or smart-phone, which communicates and exchanges data with the control unit 6, in cabled manner or preferably in wireless mode (e.g. by means of Wi-Fi, Bluetooth, IR transmission) and/or by means of an Ethernet connection on a local network (intranet), and in particular transmits the optimized winemaking model to the control unit 6 before starting the winemaking process, and receives output data from the same control unit 6 related to the winemaking process during execution and at the end of the winemaking process;
a central processing unit 9, in particular including an intranet server and/or an Internet server usable on-demand with SaaS (Software as a Service) logic, provided with a memory adapted to store a winemaking database 10, storing historical data related to past winemaking processes to be used as reference data for the winemaking process to be undertaken, adapted to manage, by means of an appropriate program and set of software instructions, the same winemaking database 10 and an extraction logic for extraction from such database of optimized winemaking models (in particular by implementing a neural network); and
appropriate communication infrastructures 11 (with wireless, Wi-Fi, Bluetooth, IR, Ethernet and/or Internet technology) to allow data exchange between the control unit 6 aboard the tank, the local processing unit 8 and the central processing unit 9; in particular, the local processing unit 8 accesses the central processing unit 9 either in wireless manner via Internet protocol or via an Intranet local network, in wireless or wired manner.

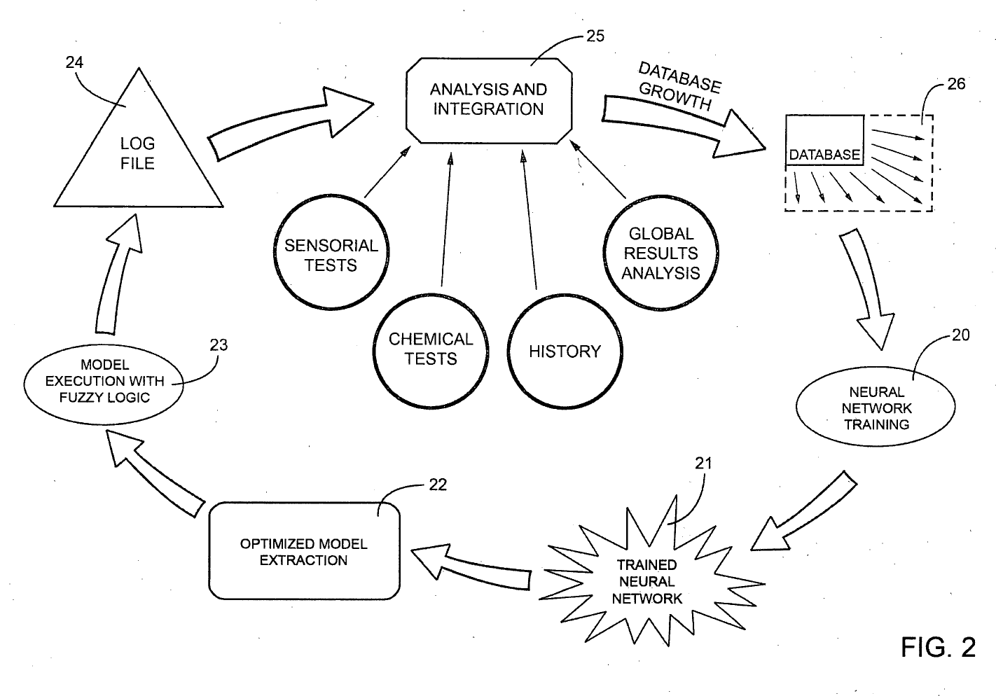

The winemaking process, implemented by the automated winemaking system 1, under the supervision of a user/supervisor, will now be described by reference also to FIG. 2. Further details related to the single process steps and corresponding operations executed by the control unit 6, by the local processing unit 8 and/or by the central processing unit 9 will be provided below.

As grape harvesting approaches, the user/supervisor of the automated winemaking system 1 will sample the grapes directly at the vineyard according to rules of good winemaking practice to subject them to chemical/physical/sensorial tests, in order to establish the best date for starting harvesting and collect information useful for defining the best winemaking strategy for the particular batch of grapes.

Having obtained such data, by means of a local processing unit 8 and via the Internet (or Intranet), the user/supervisor accesses the central processing unit in which the winemaking database 10 and the program implementing the neural network for extraction of the optimized winemaking models are stored, firstly training the neural network with training sets (i.e. input/output pairs, or associations) already present in the database itself and related to passed winemaking processes to be used as reference; this step of training is indicated by reference 20 in FIG. 2.

After the end of the neural network training procedure, as shown in step 21, the user/supervisor enters the new input data obtained from the grapes sampled at the vineyard and the winemaking target data which are intended to be obtained in the forthcoming winemaking campaign.

On the basis of the received data, the central processing unit 9 extracts the optimized winemaking model to which the grape batch will be subjected for optimal processing (step 22). The result of such an extraction consists of a set of data (collected in a file of appropriate format) for managing the winemaking process, which is transmitted, wirelessly and/or via wire, to the local processing unit 8, and, from here, (again wirelessly or via wire) to the control unit 6, aboard the winemaking tank 2 intended to receive the harvested grapes.

After having inserted the appropriately crushed harvested grapes to obtain must or crushed grapes in the winemaking tank 2, the control unit 6 aboard the tank actuates the actuators 4 to implement the steps of the process and adopt the parameters contemplated by the optimized winemaking model during such process steps. During the entire fermentation process time, the control unit 6 further executes a series of parameter detections, by means of the sensors 3, and of control and adjustment operations, by means of the actuators 4, in order to precisely execute the previously received optimized winemaking model. In particular (step 23), during the steps of alcoholic fermentation, the control unit 6 implements automatic corrective actions, determined by means of fuzzy logic algorithms, to “control” the fermenting mass according to the indications contained in the optimized winemaking model; furthermore, the control unit 6 sends manual working orders, where necessary, to the user/supervisor and/or activates alarms or sound indications, and/or sends such alarms or indications by means of SMS (or other communication means), following either the detection or the prevision of process fault risks, such as fermentation stops or rather excessively rapid fermentation kinetics.

While the winemaking process is being executed, the control unit 6 records all execution data related to the same winemaking process (and, in particular, all process steps actually implemented and the parameters adopted during these process steps, including possible corrective actions) in a log file (step 24). Furthermore, the log file may be transmitted to the local processing unit 8 to be displayed by a user/supervisor (either in real-time or at predetermined intervals) on a display of the local processing unit 8.

At the end of the alcoholic fermentation process, the user/supervisor closes the log file and downloads the same log file from the control unit 6 to the local processing unit 8, again wirelessly and/or via wire, for later data analysis and integration. In particular, the log file may be integrated during time by the user/supervisor (step 25) by inserting further data concerning the particular winemaking process results and the properties of the obtained product (wine), e.g.:

produced wine batch traceability data; chemical/physical test data carried out during ageing of the same wine; data related to sensorial tasting carried out during the life of the product; data related to commercial results and possible honorable mentions; historical evolution data and global evaluation of the result obtained by the user/supervisor; and, in general, any other data deemed important and to be reconsidered for the future. The resulting log file, thus integrated, is then stored (step 26) at the discretion of the user/supervisor, in the winemaking database 10 in the central processing unit 9 (again by communicating data via Internet/Intranet) so as to guarantee the continuous growth of the database. In particular, a further training set is thus created for further training of the neural network (in form of input/output pairs), so as to be able to extract increasingly more accurate, effective optimized winemaking models.

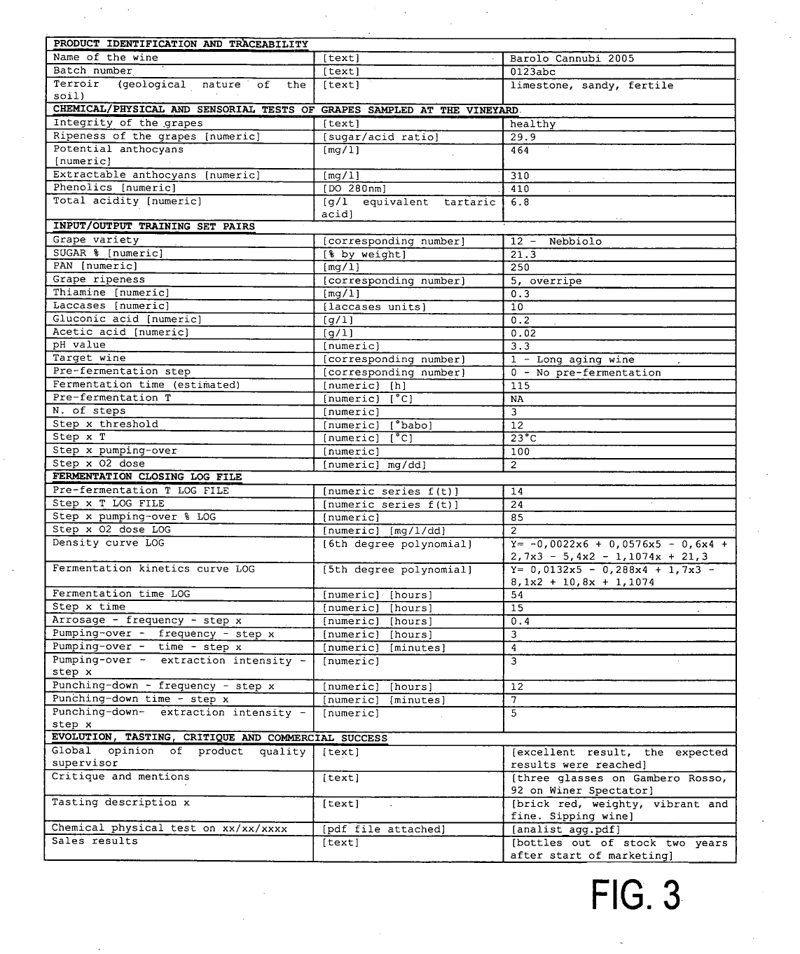

In greater detail, the winemaking database 10, on which the creation process of optimized winemaking models by means of the neural network in the central processing unit 9 is based, consists of a series of records which, by way of non-limiting example, are illustrated in FIG. 3 related to a particular winemaking process, as they may be displayed to a user/supervisor.

Such records contain: product identification and traceability data; data from chemical, physical and sensorial tests carried out on the harvested grapes; input/output training set pairs for training the neural network; data extracted from the log file related to the fermentation trend; data on the evolution of the produced wine with ageing; global evaluations of the supervisor concerning the obtained quality result; data concerning periodical tasting operations; data on the commercial life of the product, including commercial success, possible honorable mentions, etc.

As shown in FIG. 3, the product identification and traceability data include, for example: the name of the wine, the batch number, and the so-called terroir (i.e. the geological nature of the soil).

Chemical/physical and sensorial grape tests include, for example: degree of integrity and ripeness of the grapes; amounts of potential anthocyans, extractable anthocyans and phenolics; and total acidity.

As described in greater detail below, the training set pairs (input/output) include, as inputs: identification of the grape variety; the percentage of sugar; the amount of PAN (Promptly Assimilable Nitrogen); the degree of ripeness of the grapes; the amount of thiamine, laccases, gluconic acid, acetic acid; the pH value; the target for the wine to be obtained at the end of the process (e.g. wine to lay down, sipping wine, “vin nouveau”, etc.).

The training set pairs (input/output) include, as outputs: the presence of a pre-fermenting phase or not, the duration of the fermentation; the temperature during pre-fermentation; the number of steps of the winemaking process; the threshold density, the temperature, the pumping-over percentage and the oxygen dose of each of the winemaking process steps.

Data related to the closing of the fermentation log file include a series of information related to the actually realized fermentation process, e.g.: the pre-fermentation temperature; for each realized step, the temperature, the pumping-over percentage and the oxygen dose; the resulting curve of the density course; the resulting curve of the fermentation kinetics during the process; the total duration of the fermentation and the duration of each step; the duration, frequency and intensity of the arrosage, pumping-over and punching-down events which occurred during the fermentation process following the actuation of the actuators 4 by the control unit 6 aboard the winemaking tank 2.

Further data stored in the winemaking database 10 are related to a global opinion on product quality;

possible critique mentions; description of tasting events; possible further physical-chemical tests; sales results; and further possible useful notes.

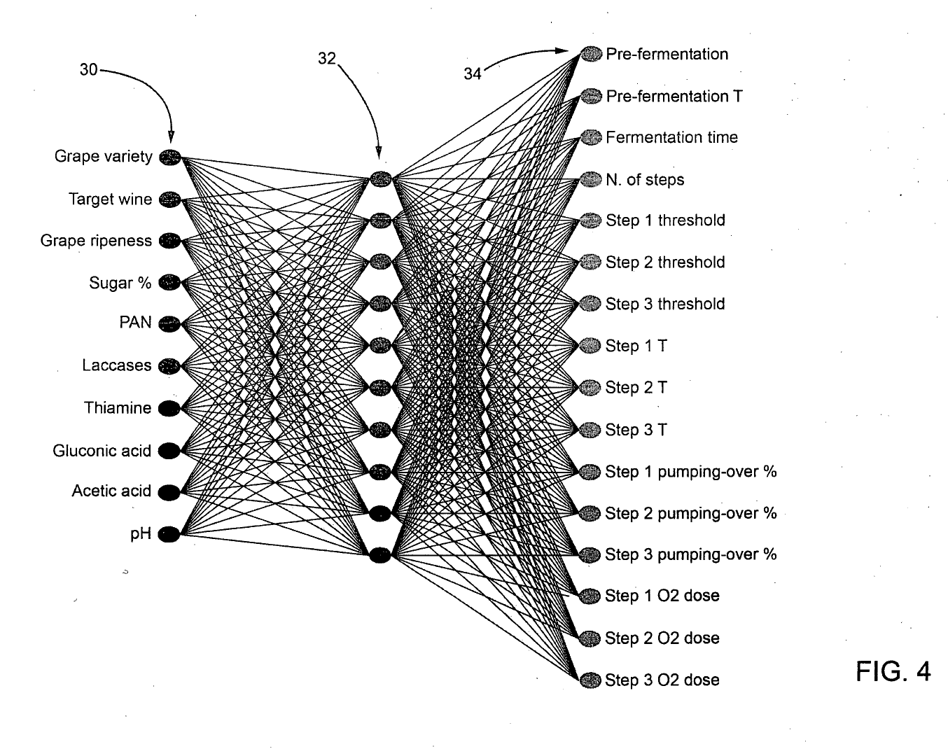

FIG. 4 shows the diagram of a possible neural network structure implemented (by means of an appropriate software program) by the central processing unit 9 for generating optimized winemaking models starting from the input data received from the user/supervisor.

In a per-se known manner, neural networks are used for processing information and supporting decisions in complex problems. A neural network may be seen as a system capable of providing an answer to a question, answer which is obtained by means of a training process using empirical data. In particular, the neural network is capable of deriving the function which links the output to the input according to the examples provided during the learning phase, so that after the learning phase, the neural network can provide an output in response to an input which may be different from the inputs used in the training examples. Therefore, the neural network is capable of interpolating and extrapolating from the training set data, which in this case are stored in the winemaking database 10. It is easy to understand that the result produced by a neural network is thus gradually more accurate the better the training of the same network.

For this reason, one of the aspects of the present invention is to create an expert system in which the winemaking database 10, containing the winemaking data and, in particular, the input/output pairs for the neural network, constantly grows, year after year, winemaking process after winemaking process. The higher the growth of the input/output pair database, the better the training of the neural network, and the answer of the neural network to subsequent queries will thus be increasingly more accurate and precise.

The initial content of the winemaking database 10 consists of a library of input/output pairs which refer to winemaking models inferred by the Applicant from a research carried out in some major European countries (including France, Spain and Italy) over the past ten years (1999-2008). Such data allow to start an initial training of the neural network so as to extract an optimized winemaking model and proceed with a first winemaking process. It is apparent that in all cases the initial content of the database may be different and limited for example to a particular area or a particular type of wine. Furthermore, an appropriate winemaking model can be generated by the user/supervisor if there are no significant data in the database.

By way of non exhaustive, non-limiting example only, FIG. 4 shows a basic diagram of the neural network which can be used in the automated winemaking system 1 for extracting optimized winemaking models.

This neural network is made of ten input neurons, indicated by reference 30, ten intermediate neurons, indicated by reference 32, and sixteen output neurons, indicated by reference 34; the synapses are equal to 260 in total. The neural network is of the one-way type, meaning that signals are propagated only from the input to the output and is of the multilayer type with error backpropagation. This type of network is the most used in expert systems today because it guarantees maximum efficacy and flexibility.

The input data in the example shown (as previously described for the winemaking database 10) consist of nine parameters characterizing the raw material being processed (obtained by sampling and chemical/physical/quality tests on grapes at the vineyard a few days before harvesting) and a target parameter, such as quality target to be obtained as final product.

The nine input data characterizing the grape being processed are in the example: grape variety type (e.g.: Nebbiolo, Barbera, Sangiovese, Chianti, Merlot, Cabernet, Tempranillo, Sirah, Pinot Nero, etc., including possible mixtures); ripeness of the grapes (e.g.: underripe, ripe, overripe, etc.); the amount of sugar expressed in percentage with respect to the grape juice; the amount of Promptly Assimilable Nitrogen (PAN) expressed in mg/l; the level of laccases expressed in number of laccases units; the amount of thiamine expressed in mg/l; the amount of gluconic acid in g/l; the amount of acetic acid expressed in g/l; and finally the pH value. The tenth input data is the quality objective target, the so-called “Target Wine” (e.g.: short, medium, long ageing wine, early-drinking wine, etc.). In all cases, it is obvious that different or further input data may be contemplated, related to the features of the grape and/or in equivalent manner of the must or crushed grapes obtained therefrom.

The output data which contribute to constituting the optimized winemaking model which is supplied to the local processing unit 8 and to the control unit 6 for controlling and managing the actual winemaking process, include: the possible implementation of a step of pre-fermentation or pre-macerating (e.g. 0=no pre-macerating step; 1=pre-macerating step present) and the temperature thereof expressed in degrees centigrade; the total duration of fermentation expressed in hours; the number of steps in which fermentation will be divided (from 1 to 3, in the example); the division thresholds of the various steps, expressed according to the density of the fermenting must, the temperature to be maintained in each step, the percentage of must to be pumped-over by means of a pump and a winemaking robot in each step, according to the total amount of must being processed; the dose of oxygen to be added in each step expressed in mg/l.

As can be easily understood, it is worth emphasizing once again that the input and output variables may be modified and increased and/or decreased according to the winemaking know-how which will be consolidated as time goes by, and the consequent orderly accumulation of knowledge that the expert system will allow to collect and organize in a scientific manner. New more or less complex neural network architectures may be created, trained by sets of increasingly numerous input/output pairs according to the needs of expert users/supervisors.

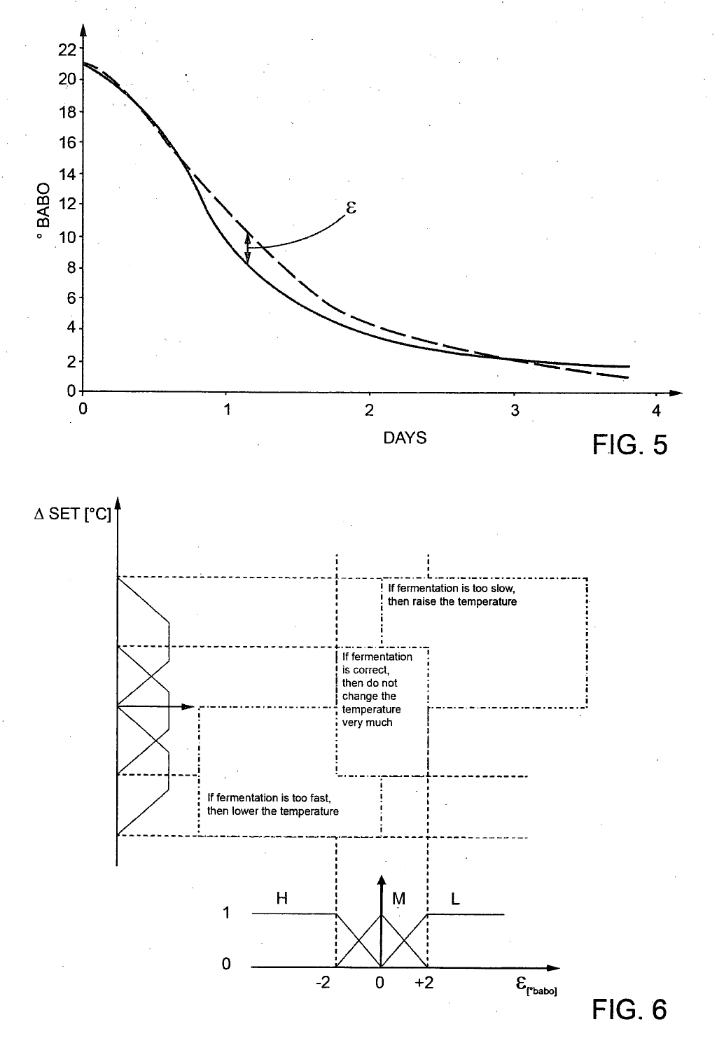

The operations carried out by the control unit 6, for controlling fermentation process in the winemaking tank 2 on the basis of the optimized winemaking model generated by the central processing unit 9 will now described in greater detail with reference to FIGS. 5 and 6.

In particular, as partially mentioned above, such an optimized winemaking models is generated by the software program aboard the central processing unit 9 by using the outputs of the neural network and subsequent post-processing thereof, and contains a series of data, including:
the number of steps in which the fermentation process is split, each step being defined by a density threshold, after having reached it the subsequent step starts;
the contemplated arrosage, pumping-over, punching-down, temperature, oxygen dose settings to be adopted during each of such steps; and
a density curve which describes the optimal provisional course of the density of the must as a function of time, during the entire fermentation process.

The control unit 6, which continuously monitors the fermentation process in real time, measures in a continuous manner parameters of the winemaking process by means of sensors 3 and compares the measurements with the optimal parameters contemplated in the optimized winemaking model. In particular, the control unit 6 determines the density of the must (by means of pressure sensors and/or flow rate sensors for measuring the produced CO₂), and continuously compares it with the one contemplated by the optimized winemaking model which is being realized, thus obtaining a deviation value E.

With this regard, FIG. 5 shown the descent curve of the optimized density course (obtained by processing output data of the neural network) with a solid line, and the real course of the density within the winemaking tank 2 (detected by the sensors 3 and measured by the control unit 6) with a dashed line; again in FIG. 5, the deviation ε detected between two courses at a given time instant is further indicated. In particular, the density of the fermenting mass is measured here in Babo degrees (grading unit of the Babo mustmeter, named after its creator, which, in a known manner, measures the weight of sugar contained in the must referred to 100 grams).

The deviation ε between the optimized course of density and the real course is used as input of a fuzzy logic (implemented by the software program executed by the control unit 6) to determine: the possible manifestation of faults of more or less severity in the fermentation process; possible alarms and/or working orders for user/supervisor, to be activated in case of the prevision of risks of faults; and the automatic actions to be undertaken to return the fermentation course as close to that contemplated by the optimized winemaking model as possible.

In order to “control” the fermenting process, the control unit 6 can act, according to the deviation ε input variable and to the values of the quantities detected by the various sensors 3, on the following parameters (which constitute the fuzzy logic output variables): temperature; amount of pumped-over must; the dose of delivered oxygen; and the amount of nutrients to be added to the fermenting mixture (in particular, Promptly Assimilable Nitrogen). It is indeed known that the fermentation process is strongly influenced by the temperature at which it occurs, the intensity and frequency of the arrosage, pumping-over and punching-down events and the amount of nutrients and oxygen made available to the yeasts.

The control unit 6 thus applies a series of rules described with fuzzy logic, which allows to calculate the corrections to be made to the output variable values according to the deviation ε input variable.

In detail, for the deviation ε a number of classes are defined (so-called “fuzzification” of the input), identified as: L (corresponding to an excessively slow fermentation); M (corresponding to a correct fermentation speed); and H (corresponding to an excessively fast fermentation).

According to the deviation value ε, a degree of membership is defined for each class; this degree of membership determines the fuzzy rules to be activated and the weight to be attributed to each of such fuzzy rules. The combined action of the fuzzy rules thus leads to determining the value of the corresponding output variable (the so-called “defuzzification” of the output).

For example, in the case of the “temperature” output variable, as diagrammatically shown in the diagram in FIG. 6, the fuzzy rules defined by the control unit 6 are of the type:

“if ε belongs to class L (excessively slow fermentation), then increase the temperature”;

“if ε belongs to class M (correct fermentation speed), then do not allow the temperature to change much”; and “if ε belongs to class H (excessively fast fermentation), then lower the temperature”.

The output variable is indicated by ΔSET and represents the temperature set-point deviation, with respect to the value defined by the optimized winemaking model for the particular step of the fermentation process being realized. The diagrams in FIG. 6 show the values (comprised between 0 and 1) of the membership functions of classes L, M and H within the various temperature ranges, and the values (again comprised between 0 and 1) of the output functions for determining values of the temperature deviation ΔSET on the basis of the values of the aforesaid membership functions.

For the other output variables, as for determining fermentation faults, a set of rules are defined with a similar logic, as can be easily understood by a person skilled in the art (and which, for this reason, are not described here in detail).

The advantages that the described automated winemaking system and corresponding winemaking method allow to obtain are clear from the previous discussion.

In any cases, it is worth emphasizing that the proposed system allows to adopt a scientific approach to winemaking process planning and control, based on choices made according to reference data related to past winemaking processes, organized in orderly, systematic manner within a specific database. It follows that the execution parameters of the winemaking process will no longer be the result of autonomous, uncertain processing by expert personnel (as such, prone to possible errors and poorly systematic), but instead a repeatable, deterministic result of automated processing. The use of an optimized model (generated from the data contained in the database) for monitoring the process and deciding possible corrective actions, allows to control fermentation while it is being executed in automated, accurate manner, contrarily to the case in which, as occurs today, the process is controlled by expert personnel on the basis of either only experience or possibly also on data detected by sensors aboard the tank.

In particular, the use of a neural network in the decision-making process allows to obtain continuous improvements in time according to the expansion of the winemaking process database. The structure of the neural network in the automatic winemaking system 1 is indeed of evolving dynamic nature, being subjected to updates and improvements consequent to the increase in winemaking know-how.

Also for this reason, the possibility of offering to the users of the system the utilization of the winemaking database 10 and the associated neural network with on-demand logic, e.g. with SaaS logic via the Internet is thus advantageous, so as to easily allow continuous updates of the software instruments at the service of the winemaking process.

During execution of the winemaking process, the use of a fuzzy logic is moreover advantageous to support interventions of the control unit 6 aboard the winemaking tank 2, and allowing to obtain high levels of accuracy and reliability with a good robustness with regards to errors. The use of a fuzzy logic allows to advantageously obtain the output variable values using qualitative rules, without requiring formal modeling and mathematics of the controlled system (and the relations between inputs, e.g. the deviation ε of the density of the fermenting mass, and outputs, e.g. the temperature to be applied to the winemaking tank 2).

In particular, the determination of correcting parameters for the winemaking process on the basis of continuous monitoring of the deviation of the real density values with respect to those contemplated by the optimized winemaking model, advantageously allows to follow the fermenting mass in its normal evolution from juice obtained from the crushing of grapes to the high quality wine obtained as the final fermentation product.

From the point of view of practical realization of the automated winemaking system, the use of wireless type infrastructures for communicating data 11 is further advantageous in order to avoid the known problems related to the use of wired solutions in environments, such as cellars, which are humid and oxidizing, in which the winemaking tanks 2 are situated.

It is finally apparent that changes and variations can be made to what described and illustrated herein without departing from the scope of protection of the present invention as defined in the accompanying claims.

In particular, it is apparent that, as previously described, the architecture (and the input and output variables) of the neural network (and possibly also of the fuzzy logic) may vary with respect to what shown and illustrated, also over years and as the knowledge of the winemaking process and the winemaking database 10 increase.

Furthermore, a different parameter instead of the density of the fermenting mixture in the winemaking tank can be monitored, indicating the amount, or production measure, of alcohol of the same mixture; e.g. the amount of carbon dioxide (CO₂) produced during the fermentation process may be monitored.

The winemaking database 10 stored in the central processing unit 9 may be advantageously organized, in the case of on-demand logic supply, so as to include a different sector for each of the users, so that each user may have access to his own past winemaking data only (i.e. without having access to the database sections of other users) for managing their own winemaking process. If the program for processing of the optimized winemaking models is instead provided with an end user license, the automated winemaking system 1 may instead not comprise a single database residing in the central server (there being in this case contemplated several databases, distributed at the local processing units of the various users).

Finally, during the creation of the optimized winemaking model, the corresponding program may also offer to the user/supervisor the possibility of interacting for selecting only the data related to particular past winemaking processes in the winemaking database 10 which have features similar to that of the process to perform.

1. An automated winemaking system, configured to control the execution of a winemaking process for the alcoholic fermentation of must obtained from a batch of grapes and for the transformation thereof into wine in a winemaking tank, comprising:
first processing means, configured to generate an optimized winemaking model, based on winemaking data related to corresponding winemaking processes and in response to input data including characteristics of said batch of grapes and/or must; and
second processing means, configured to control actuator means, designed to act on the must contained in said winemaking tank, according to said optimized winemaking model, so that parameters of said winemaking process are optimized for the characteristics of said batch of grapes and/or must.

2. A system according to claim 1, further comprising a database adapted to store said winemaking data; wherein said first processing means are configured to implement a neural network related to said winemaking process for generating said optimized winemaking model by: training of said neural network according to winemaking data stored in said database related to reference winemaking processes;
and processing of output data supplied by said neural network trained in response to said input data.

3. A system according to claim 2, wherein said database is designed to store a plurality of input data/output data associations of said neural network related to said reference winemaking processes, in order to training of said neural network.

4. A system according to claim 3, wherein said input data include data related to chemical and/or physical and/or qualitative features of said batch of grapes and to a quality target for said wine, and said output data include data related to process steps for executing said alcohol fermentation and/or winemaking parameters associated to said process steps; and wherein said optimized winemaking model includes an optimized trend of the density of the mixture fermenting in said winemaking tank, as a function of the fermentation time.

5. A system according to claim 3, wherein said first processing means comprise a memory configured to store said database, and are further configured so as to store in said database a new association of input data/output data related to said winemaking process, after its conclusion, to be used for training of said neural network.

6. A system according to claim 1, wherein said second processing means are configured to: control said actuator means for executing a number of process steps associated to said optimized winemaking model;
detect actual winemaking parameters by means of sensor means present aboard said winemaking tank during the execution of said process steps; and control said actuator means so as to actuate corrective actions with respect to said process steps, according to the comparison between said actual winemaking parameters and optimized winemaking parameters contemplated by said optimized winemaking model.

7. A system according to claim 6, wherein said second processing means are configured to report faults and/or activate alarm signals, according to the comparison between said actual winemaking parameters and said optimized winemaking parameters contemplated by said optimized winemaking model; in particular, said faults comprising a risk of stopping of said fermentation and/or a risk of excessively rapid fermentation kinetics.

8. A system according to claim 6, wherein said second processing means are configured to determine a deviation (ε) between a value of one or more of said actual winemaking parameters and a corresponding value of one or more of said optimized winemaking parameters, and to automatically actuate said corrective actions on the mixture fermenting inside said winemaking tank by acting on said actuator means, according to said deviation (ε).

9. A system according to claim 8, wherein said second processing means are configured to implement fuzzy logic algorithms for determining said corrective actions according to said deviation (ε).

10. A system according to claim 9, wherein said fuzzy logic algorithms are designed to determine, based on said deviation (ε), corrective values to be made to one or more of the following winemaking parameters by means of said actuator means: the temperature of said mixture; an amount of mixture to subject to a “pumping-over” operation and a corresponding frequency of such operation; an amount of mixture to be subjected to an “arrosage” operation and a corresponding frequency of such operation; an amount of mixture to be subjected to a “punching-down” operation and a corresponding frequency of such operation; a dose of oxygen to be dispensed inside said winemaking tank; an amount of one or more nutrient substances to be added to said mixture.

11. A system according to claim 6, wherein said winemaking parameters include a trend of the density of the mixture fermenting in said winemaking tank as a function of the fermentation time; and wherein said second processing means are configured to control said actuator means so that an actual trend of said density corresponds to an optimized trend contemplated by said optimized winemaking model.

12. A system according to claim 1, wherein said second processing means are configured to generate, after conclusion of said winemaking process, a log file containing data related to said concluded winemaking process, and to send said log file to said first processing means; and wherein said first processing means are configured to store in a database, adapted to store said winemaking data, data related to said log file, so as to increase the content of said database.

13. A system according to claim 1, wherein said second processing means comprise a control unit designed to be coupled to said winemaking tank, and a local processing unit configured to communicate with said control unit; and wherein said first processing means comprise a central processing unit configured to implement a wireless data exchange with said local processing data.

14. A system according to claim 13, wherein said central processing unit is configured to transmit said optimized winemaking model to said local processing unit according to an on-demand logic; and wherein said local processing unit is configured to communicate said optimized winemaking model to said control unit, for executing said winemaking process.

15. An electronic device, configured to implement the first processing means of said automated winemaking system, according to claim 1.

16. An electronic device according to claim 15, further comprising a database configured to store said winemaking data.

17. An electronic device, configured to implement the second processing means of said automated winemaking system, according to claim 1.

18. A software program product, comprising software instructions designed to be executed by said first processing means of said automated winemaking system, so that said first processing means are configured according to claim 1.

19. A software program product, comprising software instructions designed to be executed by said second processing means of said automated winemaking system, so that said second processing means are configured according to claim 1.

20. A winemaking method for controlling the execution of a winemaking process for the alcoholic fermentation of must obtained from a batch of grapes and the transformation thereof into wine in a winemaking tank, comprising:
controlling actuator means, designed to act on said winemaking tank, according to an optimized winemaking model automatically generated according to winemaking data related to corresponding winemaking processes and in response to input data including characteristics of said batch of grapes and/or must, so that parameters of said winemaking process conform to said optimized winemaking model.

21. A method according to claim 20, comprising the steps of:
storing said winemaking data in a database;
training a neural network, related to said winemaking process, according to winemaking data contained in said database related to reference winemaking processes; and
processing output data, supplied by said neural network trained in response to said input data, to generate said optimized winemaking model.

22. A method according to claim 21, wherein said step of storing comprises storing in said database a plurality of input data/output data associations of said neural network related to said reference winemaking processes; further comprising the step of storing in said database, after conclusion of said winemaking processes, a new association of said input data/output data related to said concluded winemaking process, to be used for training of said neural network.

23. A method according to any of claim 20, wherein said step of controlling comprises: controlling said actuator means for performing a number of process steps associated to said optimized winemaking model; detecting, during the execution of said process steps, actual winemaking parameters by means of sensor means present aboard said winemaking tank; and further controlling said actuator means so as to actuate corrective actions with respect to said process steps, according to the comparison between said actual winemaking parameters and optimized winemaking parameters contemplated by said optimized winemaking model.

24. A method according to claim 23, further comprising the step of signaling faults and/or activating alarm warnings, according to the comparison between said actual winemaking parameters and said optimized winemaking parameters contemplated by said optimized winemaking model; said step of signaling faults and/or activating alarm warnings comprising the step of foreseeing a risk of stopping of said fermentation and/or a risk of excessively rapid fermentation kinetics.

25. A method according to claim 23, wherein said step of controlling further comprises applying fuzzy logic algorithms for determining corrective actions to be automatically implemented on the mixture in said fermentation tank by acting on said actuator means, according to a deviation (ε) between a value of one or more of said actual winemaking parameters and a corresponding value of one or more of said optimized winemaking parameters.

26. A winemaking method for controlling the execution of a winemaking process for the alcoholic fermentation of must obtained from a batch of grapes and the transformation thereof into wine in a winemaking tank, comprising the steps of:
automatically generating an optimized winemaking model according to winemaking data related to corresponding winemaking processes and in response to input data including characteristics of said batch of grapes and/or must; and
sending data related to said optimized winemaking model to actuator means, designed to act on said must contained in said winemaking tank, so as to cause said actuator means to produce an activity aimed at ensuring that parameters of said winemaking process conform to said optimized winemaking model and are optimized for the characteristics of said batch of grapes and/or must.
